(19) United States
(12) Patent Application Publication
(10) Pub. No.: US 2024/0318035 A1
(43) Pub. Date: Sep. 26, 2024

(54) FLUORINE-FREE HYDROPHOBIC COATING

(71) Applicant: COTEC GmbH, Karlstein (DE)

(72) Inventors: Jakob Schilling, Muhital (DE); Miena Habibzai, Altenstadt (DE)

(21) Appl. No.: 18/411,066

(22) Filed: Jan. 12, 2024

Related U.S. Application Data
(60) Provisional application No. 63/492,036, filed on Mar. 24, 2023.

(51) Int. Cl. C09D 183/04

(52) U.S. Cl. CPC C09D 183/04

(57) ABSTRACT

A fluorine-free coating composition comprises a functionalized poly(siloxane) having a poly(siloxane) segment and at least one trialkoxysilane terminal group. When applied to a substrate, the fluorine-free coating composition forms a transparent hydrophobic coating. The transparent hydrophobic coating may have properties such as easy-to-clean and environmental stability. As such, the fluorine-free coating composition is an environmentally friendly substitute to existing ophthalmics coatings based on PFASs (per- or polyfluorinated alkyl substances).

### RELATED APPLICATIONS

This application claims priority to U.S. Provisional Application No. 63/492,036, filed on Mar. 24, 2023, titled FLUORINE-FREE HYDROPHOBIC COATING, the entire disclosure of which is incorporated herein by reference.

### FIELD

disclosure relates to fluorine-free coating compositions that form a transparent hydrophobic coating when applied to a substrate.

### BACKGROUND

Coating compositions are used in ophthalmics to provide desired properties to the substrate, such as a lens. For some applications, coatings with hydrophobicity and easy-to-clean properties are preferred. Currently, there are products based on PFASs (per- or polyfluorinated alkyl substances) that provide such properties. However, PFASs are known to cause harm to the environment because they are difficult to break down.

### SUMMARY

The present disclosure provides a fluorine-free coating composition comprising a functionalized poly(siloxane) represented by the formula:

X-A-SiR¹R²—[O—SiR¹R²]ₙ—O—SiR¹R²—B—X

X is a trialkoxysilane group at each occurrence. A and B are divalent groups, respectively. R¹ and R² are respectively and independently at each occurrence a hydrogen atom, a methyl group, ethyl group, or phenyl group. Also, n is an integer from 1 to 150. When applied to a substrate, the fluorine-free coating composition forms a transparent hydrophobic coating.

The present disclosure further provides a fluorine-free coating composition comprising a functionalized poly(siloxane) represented by the formula:

X-D-SiR¹R²—[O—SiR¹R²]ₙ—O—SiR¹R²—Y

X is a trialkoxysilane group. D is a divalent group. R¹ and R² are hydrogen atom, or methyl, ethyl, or phenyl groups, respectively and independently at each occurrence. Also, n is an integer from 1 to 150. Y is a linear or branched C1-C10 alkyl, phenyl, alkyl phenyl, or alkenyl group. When applied to a substrate, the fluorine-free coating composition forms a transparent hydrophobic coating.

The present disclosure further provides a fluorine-free coating composition comprising a functionalized poly(siloxane) represented by the formula:

[C(CₛH₂ₛ₊₁)(QX)₂]-E-SiR¹R²—[O—SiR¹R²]ₙ—O—SiR¹R²—Y

X is a trialkoxysilane group. Q is a divalent group. E is a divalent group comprising saturated hydrocarbon chain, substituted phenyl, urethane, ether, or ester groups, or combination thereof. R¹ and R² are hydrogen atom, or methyl, ethyl, or phenyl groups, respectively and independently at each occurrence. Also, n is an integer between 1 and 150, and s is an integer from 0 to 3. Y is a linear or branched C1-C10 alkyl, phenyl, alkyl phenyl, or alkenyl group. When applied to a substrate, the fluorine-free coating composition forms a transparent hydrophobic coating.

### DETAILED DESCRIPTION

Coating compositions are described in the present disclosure. The coating compositions are fluorine-free, and comprise a functionalized poly(siloxane). When applied to a substrate, the coating compositions form a transparent hydrophobic coating.

Existing hydrophobic coatings for ophthalmics with easy-to-clean properties are based on PFASs (per- or polyfluorinated alkyl substances). These PFASs are under severe scrutiny in the U.S. and the European Union, with a number of named substances within the class already banned in both markets. More PFASs, and possibly all of them, are expected to be banned by the second half of the 2020s. Therefore, there is a need for fluorine-free coatings with substantially similar properties as the existing PFAS-based coatings, as well as other desirable properties, such as hydrophobicity, transparency, easy-to-clean, and environmental stability.

To address this issue, in accordance with the present disclosure, fluorine-free coating compositions of Formulas I, II, and III are provided, which are environmentally friendly substitutes to the existing PFAS-based coatings.

### Formula I

As discussed above, the coating compositions comprise a functionalized poly(siloxane). In accordance with the present disclosure, the functionalized poly(siloxane) may be represented by the formula:

X-A-SiR¹R²—[O—SiR¹R²]ₙ—O—SiR¹R²—B—X (I)

X is a trialkoxysilane group at each occurrence. Suitable examples of the trialkoxysilane group include —Si(OCₓH₂ₓ₊₁)₃ where x is 1 to 5, including —Si(OCH₃)₃ and —Si(OC₂H₅)₃, independently at each occurrence of X. In accordance with the present disclosure, X may be —Si(OCH₃)₃ or —Si(OC₂H₅)₃, independently at each occurrence. For example, Formula (I) may be:

Si(OCH₃)₃-A-SiR¹R²—[O—SiR¹R²]ₙ—O—SiR¹R²—B—Si(OCH₃)₃, or

Si(OCH₃)₃-A-SiR¹R²—[O—SiR¹R²]ₙ—O—SiR¹R²—B—Si(OC₂H₅)₃.

A and B are divalent groups, respectively. In accordance with the present disclosure, A and B may comprise divalent saturated hydrocarbon groups, respectively. The divalent saturated hydrocarbon group is a linear or branched hydrocarbon chain generally represented by the formula —C_{y}H_{2y}—. The number of carbon atoms y is not particularly limited, and may range from 1 to 10.

In accordance with the present disclosure, A and/or B may consist of a divalent saturated hydrocarbon group and no other functional groups. For example, A and/or B may be —CH₂—CH₂—CH₂— or —CH₂—CH₂— group. A and/or B may be formed by hydrosilylation reaction between a silane and an alkene, for example, between a poly(siloxane) having Si—H terminals and a trialkoxysilane (e.g., trimethoxysilane, triethoxysilane) having an alkene terminal (e.g., allyl, vinyl):

H—SiR¹R²—[O—SiR¹R²]ₙ—O—SiR¹R²—H+2H₂C═CHCH₂—Si(OCH₃)₃→Si(OCH₃)₃—CH₂—CH₂—CH₂—SiR¹R²—[O—SiR¹R²]ₙ—O—SiR¹R²—CH₂—CH₂—CH₂—Si(OCH₃)₃ (1)

A and/or B may also be formed by hydrosilylation reaction between a poly(siloxane) having alkene terminals and a trialkoxysilane having the formula H—Si(OCₓH₂ₓ₊₁)₃, for example:

H₂C═CH—SiR¹R²—[O—SiR¹R²]ₙ—O—SiR¹R²—CH=CH₂+2H—Si(OCH₃)₃ →Si(OCH₃)₃—CH₂—CH₂—SiR¹R²—[O—SiR¹R²]ₙ—O—SiR¹R²—CH₂—CH₂—Si(OCH₃)₃ (2)

In accordance with the present disclosure, in addition to the divalent saturated hydrocarbon group, A and/or B may further comprise other functional groups, for example, urea, urethane, ether, or amide groups. A and/or B may be formed by reaction between an isocyanate group and a nucleophilic group (e.g., amine, alcohol), for example, between a poly(siloxane) having alcohol terminals and a trialkoxysilane (e.g., trimethoxysilane, triethoxysilane) having an isocyanate terminal:

H₂N—(CH₂)₃—SiR¹R²—[O—SiR¹R²]ₙ—O—SiR¹R²—(CH₂)₃—NH₂+2O═C═N—(CH₂)₃—Si(OCH₃)₃→Si(OCH₃)₃—(CH₂)₃—NHCONH—(CH₂)₃—SiR¹R²—[O—SiR¹R²]ₙ—O—SiR¹R²—(CH₂)₃—NHCONH—(CH₂)₃—Si(OCH₃)₃ (3)

Ether groups in A and/or B may be formed by reaction between an alkoxide and an organohalide (Williamson ether synthesis), where the organohalide may be chloride, bromide, or iodide, for example:

HO—(CH₂)₃—SiR¹R²—[O—SiR¹R²]ₙ—O—SiR¹R²—(CH₂)₃—OH+2Br—R³+base→R³O—(CH₂)₃—SiR¹R²—[O—SiR¹R²]ₙ—O—SiR¹R²—(CH₂)₃—OR³ (4)

R³ is functionalized in order to attach the X (trialkoxysilane) terminal groups by subsequent reactions. For example, R³ may have an allyl group and the X (trialkoxysilane) terminal groups are attached by hydrosilylation. R³ may also have a carboxylic ester group (e.g., R³=—C₃H₆COOCH₃) and further reacted with a trialkoxysilane having an amine terminal (e.g., H₂N—C₃H₆—Si(OCH₃)₃) to form an amide group. In accordance with the present disclosure, R³ may have a C2 to C12 saturated hydrocarbon chain.

R¹ and R² are respectively and independently at each occurrence a hydrogen atom, a methyl group, ethyl group, or phenyl group. In accordance with the present disclosure, R¹ and R² may both be —CH₃ group. In accordance with the present disclosure, the —SiR¹R²— unit may be —Si(CH₃)₂—, —Si(CH₃)(Ph)-, —Si(Ph)₂-, or —Si(CH₃)H—, independently at each occurrence.

In accordance with the present disclosure, the number of repeating units n in —[O—SiR¹R²]ₙ— may be an integer from 1 to 150, including 5 to 100, 10 to 50, and 15 to 25.

### Formula II

In accordance with the present disclosure, the coating composition may comprise a functionalized poly(siloxane) represented by the formula:

X-D-SiR¹R²—[O—SiR¹R²]ₙ—O—SiR¹R²—Y (II)

X is a trialkoxysilane group. Suitable examples of the trialkoxysilane group include —Si(OCₓH₂ₓ₊₁)₃ where x is 1 to 5, including —Si(OCH₃)₃ and —Si(OC₂H₅)₃. In accordance with the present disclosure, X may be —Si(OCH₃)₃.

D is a divalent group. In accordance with the present disclosure, D may comprise a divalent saturated hydrocarbon group. The divalent saturated hydrocarbon group is a linear or branched hydrocarbon chain generally represented by the formula —C_{y}H_{2y}—. The number of carbon atom y is not particularly limited, and may range from 1 to 10.

In accordance with the present disclosure, D may consist of a divalent saturated hydrocarbon group and no other functional groups. For example, D may be —CH₂—CH₂—CH₂— or —CH₂—CH₂— group. D may be formed by hydrosilylation reactions between a silane and an alkene, for example, analogous to Reactions (1) and (2) described above.

In accordance with the present disclosure, in addition to the divalent saturated hydrocarbon group, D may further comprise other functional groups, for example, urea, urethane, ether, or amide groups. D may be formed by reactions between an isocyanate group and a nucleophilic group (e.g., amine, alcohol), for example, analogous to Reaction (3) described above. D may also be formed by Williamson ether synthesis followed by attachment of an X (trialkoxysilane) terminal group, analogous to Reaction (4) and the following reactions described above.

R¹ and R² are respectively and independently at each occurrence a hydrogen atom, a methyl group, ethyl group, or phenyl group. In accordance with the present disclosure, R¹ and R² may both be —CH₃ group. In accordance with the present disclosure, the —SiR¹R²— unit may be —Si(CH₃)₂—, —Si(CH₃)(Ph)-, —Si(Ph)₂-, or —Si(CH₃)H—, independently at each occurrence.

In accordance with the present disclosure, the number of repeating units n in —[O—SiR¹R²]ₙ— may be an integer from 1 to 150, including 5 to 100, 10 to 50, and 15 to 25.

Y is a linear or branched C1-C10 alkyl, phenyl, alkyl phenyl, or alkenyl group. Suitable examples of Y include, but are not limited to, a vinyl, allyl, butenyl, methyl, butyl, or phenyl group.

### Formula III

In accordance with the present disclosure, the coating composition may comprise a functionalized poly(siloxane) represented by the formula:

[C(CₛH₂ₛ₊₁)(QX)₂]-E-SiR¹R²—[O—SiR¹R²]ₙ—O—SiR¹R²—Y

X is a trialkoxysilane group. Suitable examples of the trialkoxysilane group include —Si(OCₓH₂ₓ₊₁)₃ where x is 1 to 5, including —Si(OCH₃)₃ and —Si(OC₂H₅)₃. In accordance with the present disclosure, X may be —Si(OCH₃)₃.

Q is a divalent group. In accordance with the present disclosure, Q may comprise a divalent saturated hydrocarbon group. The divalent saturated hydrocarbon group is a linear or branched hydrocarbon chain generally represented by the formula —C_{y}H_{2y}—. The number of carbon atom y is not particularly limited, and may range from 1 to 10.

In accordance with the present disclosure, Q may consist of a divalent saturated hydrocarbon group and no other functional groups. For example, Q may be —CH₂—CH₂—CH₂— or —CH₂—CH₂— group. Q may be formed by hydrosilylation reaction between a silane and an alkene, for example,

[(H₂C═CH—CH₂)₂C(CₛH₂ₛ₊₁)]-E-SiR¹R²—[O—SiR¹R²]ₙ—O—SiR¹R²—Y+2H—Si(OCH₃)₃→[(Si(OCH₃)₃—CH₂—CH₂—CH₂)₂C(CₛH₂ₛ₊₁)]-E-SiR¹R²—[O—SiR¹R²]ₙ—O—SiR¹R²—Y (5)

In accordance with the present disclosure, in addition to the divalent saturated hydrocarbon group, Q may further comprise other functional groups, for example, urea, urethane, thiourethane, ether, or amide groups. Q may be formed by reaction between an isocyanate group and a nucleophilic group (e.g., amine, alcohol), for example,

[(CH₂OH)₂C(CₛH₂ₛ₊₁)]-E-SiR¹R²—[O—SiR¹R²]ₙ—O—SiR¹R²—Y+2O═C═N—(CH₂)₃—Si(OCH₃)₃ →[(Si(OCH₃)₃—(CH₂)₃—NHCOO—CH₂)₂C(CₛH₂ₛ₊₁)]-E-SiR¹R²—[O—SiR¹R²]ₙ—O—SiR¹R²—Y (6)

E is a divalent group and may comprise saturated hydrocarbon chain, substituted phenyl, urethane, ether, or ester groups, or combination thereof. In accordance with the present disclosure, E may be a divalent group represented by —CᵣH₂ᵣ—O—C_{q}H_{2q}—, for example, an ether group —CH₂—O—C₃H₆—. The values of r and q may be integers between 0 and 5, respectively.

R¹ and R² are respectively and independently at each occurrence a hydrogen atom, a methyl group, ethyl group, or phenyl group. In accordance with the present disclosure, R¹ and R² may both be —CH₃ group. In accordance with the present disclosure, the —SiR¹R²— unit may be —Si(CH₃)₂—, —Si(CH₃)(Ph)-, —Si(Ph)₂-, or —Si(CH₃)H—, independently at each occurrence.

In accordance with the present disclosure, the number of repeating units n in —[O—SiR¹R²]ₙ— may be an integer from 1 to 150, including 5 to 100, 10 to 50, and 15 to 25.

In accordance with the present disclosure, s in the branch —(CₛH₂ₛ₊₁) may be an integer from 0 to 3. For example, the branch —(CₛH₂ₛ₊₁) may be —(C₂H).

In an aspect of the present disclosure, the branch —(CₛH₂ₛ₊₁) may be substituted with a phenoxy group. In this aspect, the functionalized poly(siloxane) is represented by the formula:

[C(OPh)(QX)₂]-E-SiR¹R²—[O—SiR¹R²]ₙ—O—SiR¹R²—Y

Y is a linear or branched C1-C10 alkyl, phenyl, alkyl phenyl, or alkenyl group. Suitable examples of Y include, but are not limited to, a vinyl, allyl, butenyl, methyl, butyl, or phenyl group.

In an aspect of the present disclosure, the branched group [C(CₛH₂ₛ₊₁)(QX)₂]— may have a heteroatom as the center atom. For example, when the center atom is N, the functionalized poly(siloxane) is represented by the formula:

[(QX)₂N]-E-SiR¹R²—[O—SiR¹R²]ₙ—O—SiR¹R²—Y

### Method of Application

In accordance with the present disclosure, the coating compositions in accordance with formulas I-III comprise the functionalized poly(siloxane) and a solvent. Suitable examples of the solvent include acetone, butanone, and butylacetate, 3-methoxybutyl acetate, tetrahydrofuran, dichloromethane, chlorofom ethylenecarbonate, propylencarbonate, diethylcarbonate, and combinations or derivatives thereof. The solvent may be fully fluorine free. In accordance with the present disclosure, the coating compositions may consist of the functionalized poly(siloxane) and the solvent, without any other components. In accordance with the present disclosure, the coating compositions may also further comprise additives such as wetting agents, leveling agents, viscosity modifiers, and combination thereof, in an amount of 0-5 weight % based on total solids.

Suitable substrates for applying the coating composition include, for example, optical lenses, windows, SiO₂ surfaces, metals and metal oxides, and exterior sheathing panels of a building. The method of application of the coating composition include, but are not limited to physical vapor deposition (PVD), spray coating, dip coating, and drop-on-demand printing. In accordance with the present disclosure, the coating composition may be applied by PVD using any existing PVD machines in the ophthalmic industry. An exemplary PVD process may include activating the substrate surface by known methods (e.g., chemical etching, plasma treatment, and ion bombardment), filling a carrier with the coating composition, applying heat in the PVD machine to evaporate the coating composition under reduced pressure (e.g., below 100 mbars), and depositing the evaporated functionalized poly(siloxane) onto a substrate. Depending on the particular functionalized poly(siloxane), solvent, and method of application, the coated substrate may require specific conditions for curing, for example, storing the coated substrate for a certain time at elevated temperature and/or elevated levels of humidity.

### Properties

When applied to a substrate, the coating composition forms a transparent hydrophobic coating. The hydrophobicity of the coating can be measured in terms of the contact angle between water and air on the coated substrate surface. In accordance with the present disclosure, the initial water-air contact angle may be 100° or more, including 108° or more and 111° or more.

In accordance with the present disclosure, the coating may have abrasion resistance, that is, the coating maintains a certain hydrophobicity after abrasion. In accordance with the present disclosure, the coating may have a loss of water-air contact angle of less than 15%, including less than 6% and less than 3%, over 6400 abrasion cycles by cotton fabric with a contact area of 3.6 cm² and a total load of 2.5 kg, as compared to the initial water-air contact angle. The traveling distance of the cotton fabric during the abrasion cycles may be, for example, 3 cm between endpoints. It should be understood that abrasion resistance can be tested with various abrasion cycles, contact area, load, and test fabric. For example, with 6400 or less abrasion cycles by cotton fabric, a contact area of 3.6 cm² or more, and a total load of 2.5 kg or less, the coating may have a loss of water-air contact angle of less than 15%, including less than 6% and less than 3%, as compared to the initial water-air contact angle.

In addition to water-air contact angle, air-hexadecane contact angle and air-methyleneiodide (CH₂12) contact angle are commonly measured to calculate the surface energy of the coating. In accordance with the present disclosure, the initial air-hexadecane contact angle may be 30° or more, including 450 or more, 50° or more, and 600 or more. In accordance with the present disclosure, the initial air-methyleneiodide (CH₂12) contact angle may be 450 or more, including 700 or more, 750 or more, 80° or more, and 900 or more. In accordance with the present disclosure, the surface energy of the coating may be 15-25 mN/m, including 16-24 mN/m and 18-22 mN/m.

In accordance with the present disclosure, the coating may have self-cleaning ability. Self-cleaning ability can be measured in terms of the sliding angle, which is determined by placing a droplet of water (or other liquids) on a level substrate and increasing the inclination continuously until the droplet begins to move on its own. In accordance with the present disclosure, the coating may have a water drop sliding angle below 20°, including below 16°, below 10°, below 7.5°, and below 6°. As used herein, coatings having a “self-cleaning ability” have a water drop sliding angle below 20°.

In accordance with the present disclosure, the coating may have high transparency and low haze such that it does not negatively influence the optical properties of the coated article. In accordance with the present disclosure, the coated substrate may have a transmission of 97% or more, including 97.8% or more and 98.2% or more. In accordance with the present disclosure, the coated substrate may have a haze of 0.8 or less, including 0.63 or less, 0.14 or less, and 0.08 or less. In accordance with the present disclosure, when the coating is applied on a smooth, unstructured, and transparent substrate, the transmission of the substrate does not change by more than 1%, including no more than 0.6% and no more than 0.2%, and the haze of the substrate does not change by more than 1%, including no more than 0.7%, no more than 0.2%, and no more than 0.1%.

In accordance with the present disclosure, the coating may have stability to environmental factors, such as UV-light, moisture, heat, and corrosive acids, which makes it ideal for outdoor applications.

### EXAMPLES

In accordance with the present disclosure, samples of the coating composition were prepared as described below.

### Example 1

Fill 5 grams (1.56 mmol) of α,ω-bisamino-poly-dimethyl-siloxane with a molar mass of 2,500 g/mol into a round-bottom flask, equipped with a magnetic stirring bar. At room temperature, add 0.69 grams of 3-isocyanatopropyltrimethoxysilane (94% purity, 2 eq., 3.13 mmol). Stir to combine. To the homogeneous mixture, add 10 μl dibutyl tin dilaurate in 2 ml methanol and stir for 16 hours. Remove volatiles in vacuum. Add 10 ml methanol, mix well, and set aside to settle. Once separated, retain the lower phase (containing the product) and remove the upper phase (methanol having smaller density). Wash the retained phase once with 1,3-bistrifluoromethylbenzene. Separate the phases again and retain the upper phase (containing the product) and remove the lower phase (1,3-bistrifluoromethylbenzene having larger density).

Drying in vacuum yields 4.05 grams (yield=71.75%) of product.

### Example 2

Fill 50.7 grams (16 mmol) of α,ω-bisamino-poly-dimethyl-siloxane with a molar mass of 3,200 g/mol into a round-bottom flask, equipped with a magnetic stirring bar. At room temperature, add 8.9 grams of 3-isocyanatopropyltrimethoxysilane (94% purity, 2.3 eq., 40.7 mmol). Attach a gas inlet to the round-bottom flask and flush with argon. Stir to combine. Continue stirring for 16 hours (overnight). Wash the reaction mixture three times with 15 ml of 1,3-bistrifluoromethylbenzene. Separate the phases and retain the upper phase. Drying in vacuum yields 48.03 grams (yield=80%) of product.

### Example 3

Fill 50.29 grams (7.4 mmol) of monodicarbinol-terminated-poly-dimethyl-siloxane with a molar mass of 6,720 g/mol into a two necked round-bottom flask, equipped with a magnetic stirring bar, sealed with a rubber septum, and equipped with a gas inlet. Flush with Argon. At room temperature, add 4 ml of 3-isocyanatopropyltrimethoxysilane (94% purity, 2.1 eq., 1.5 mmol) via syringe and stir to combine. Continue stirring for 16 hours (overnight). Wash the reaction mixture once with 25 ml of a perfluoropolyether solvent (Galden SV 55 from Solvay S.A.). Separate the phases and retain the upper phase. The material is not subjected to work-up and used as is. No yield is determined.

### Example 4

Fill 50.09 grams (10.9 mmol) of monoaminopropyl-terminated-poly-dimethyl-siloxane, with a molar mass of 4,600 g/mol into a two necked round-bottom flask, equipped with a magnetic stirring bar, sealed with glass-stopper, and equipped with a gas inlet. Degas the material under vacuum. Flush with Argon. Exchange the glass-stopper for a rubber septum and at room temperature, add 3.7 ml of 3-isocyanatopropyltrimethoxysilane (94% purity, 1.1 eq., 12.7 mmol) via syringe and stir to combine. Continue stirring for 16 hours (overnight). Wash the reaction mixture once with 25 ml of 1,3-bistrifluoromethylbenzene and once with 25 ml of a perfluoropolyether solvent (Galden SV 55). Separate the phases and retain the upper phase. 56.27 g of material, containing solvent, is retained. The mixture is not subjected to further work-up and used as is. No yield is determined.

The prepared coating compositions in Examples 1-4 were applied to smooth, unstructured, and transparent substrates by the physical vapor deposition method described above, and the coated specimens were tested as described below. Each composition was tested with commercially available AR-coated ophthalmic substrates (without hydrophobic treatment). For each measured property, the average value of a number of measurements was recorded, as described below.

### Initial Water-Air Contact Angle

4 coated specimens were prepared for each of the coating compositions in Examples 1-4 (16 specimens in total), and 5 measurements of initial water-air contact angle were taken on each specimen to record the average value. Initial water-air contact angles were measured on static droplets with DSA100 drop shape analyzer by Kruss Scientific. The measured initial water-air contact angles of Examples 1-4 are shown in Table 1:

TABLE 1

| Example | Initial water-air contact angle |
|---|---|
| 1 and 2 | 111° |
| 3 | 108° |
| 4 | 110° |

### Air-Hexadecane Contact Angle and Air-Methyleneiodide (CH₂12) Contact Angle

Next, the coated specimens (4 specimens for each of Examples 1-4; 16 in total) were subjected to initial air-hexadecane contact angle and air-methyleneiodide (CH₂12) contact angle measurements. 5 measurements were taken on each specimen with DSA100 drop shape analyzer by Kruss Scientific to record the average value. The measured initial air-hexadecane contact angle and air-methyleneiodide (CH₂12) contact angle of Examples 1-4 are shown in Table 2:

TABLE 2

| Example | Air-hexadecane | Air-CH₂I₂ |
|---|---|---|
| 1 and 2 | 52° | 84° |
| 3 | 33° | 69° |
| 4 | 47° | 75° |

### Surface Energy

Surface energies were calculated based on the contact angles measured on each specimen, with ADVANCE software by Kruss Scientific using the surface free energy module according to the OWRK-method. The surface energy of each specimen was calculated, and the average values for Examples 1-4 are shown in Table 3:

TABLE 3

| Example | Surface energy [mN/m] |
|---|---|
| 1 and 2 | 18 |
| 3 | 23 |
| 4 | 20 |

### Abrasion Resistance

2 out of the 4 coated specimens for each of Examples 1-4 (8 specimens in total) were subjected to abrasion testing. The abrasion testing procedure was performed on a commercially available abrasion testing system “ATS QUAD.” A cotton fabric, fixed on a circular, concave rubber stamp was placed on the surface of the sample. The area of contact between the fabric and the coated specimen is 3.6 cm². A total load of 2.5 kg is placed on the fabric and the cloth is rubbed against the specimen for a set number of cycles at a speed of 1 cycle per second and a linear travel distance of 3 cm in one direction. Each cycle is a complete movement back and forth having a total distance of 6 cm. The number of cycles is set to 800, 1600, 3200 and 6400. In between the set cycles, the water-air contact angle is measured and recorded. The measured water-air contact angles of Examples 1-4 (average of 2 specimens for each Example) after abrasion cycles are shown in Table 4:

TABLE 4

| | Water-air contact angle | | | | |
|---|---|---|---|---|---|
| | after 0 | after 800 | after 1600 | after 3200 | after 6400 |
| Example | cycles | cycles | cycles | cycles | cycles |
| 1 and 2 | 111° | 102° | 101° | 100° | 98° |
| 3 | 108° | 104° | 102° | 91° | 86° |
| 4 | 110° | 108° | 107° | 107° | 105° |

The coated specimens showed a very strong abrasion resistance in terms of loss of contact angle (water-air) of less than 15%, even less than 6%, over a full run of the abrasion cycles. In comparison, existing fluorine containing coatings are not found to show better abrasion resistance under identical conditions.

### Sliding Angle

Specimens for sliding angle measurement were prepared by coating flat surfaces of BK270 glass slides (10 cm*10 cm, 3 mm thick) by the physical vapor deposition method described above. A droplet of water was placed on a level surface of the specimens and the inclination of the surface was increased continuously, until the droplet begins to move on its own. Using DSA100 drop shape analyzer by Kruss Scientific, the angle at which the droplet begins to move was recorded as the sliding angle. The measured sliding angles of Examples 1-4 are shown in Table 5:

TABLE 5

| Example | Sliding angle |
|---|---|
| 1 and 2 | 21.7 |
| 3 | 8.5 |
| 4 | 5.2 |

The water droplet sliding angles of the specimens are within the top performing range of existing fluorine containing easy-to-clean coatings, which typically exhibit around 10° of sliding angles. Therefore, the coating compositions are shown to provide easy-to-clean properties to the coated surface, while being fully fluorine free.

### Transmission and Haze

The prepared coating compositions in Examples 1-4 were applied to stock lenses (AR-coated; without hydrophobic treatment) commercially available from Stepper by the physical vapor deposition method described above. Transmission and haze of the coated specimens were measured with Haze-Gard meter by BYK. The values obtained are shown in Table 6, including the values for an uncoated lens for comparison. Transmission is given in %, with 100% being the maximum possible value. Haze is given in %, with 0% being the lowest possible value.

TABLE 6

| Example | Transmission | Haze |
|---|---|---|
| 1 and 2 | 98.0 | 0.0 |
| 3 | 98.0 | 0.0 |
| 4 | 98.0 | 0.0 |
| uncoated | 98.0 | 0.0 |

As can be seen from the values in Table 6, the coatings have virtually no impact on the optical properties of the lenses, with changes in transmission below 5% and haze below 1% which are considered the threshold levels for being normally detectable by human eye. The differences in the transmission and haze of the specimens were hardly detectable by the test method or distinguishable by human eye, and thus can be considered non-existent.

While the present disclosure describes exemplary aspects of coating compositions, articles, and methods in detail, the present disclosure is not intended to be limited to the disclosed aspects. Also, certain elements of exemplary aspects disclosed herein are not limited to any exemplary aspects, but instead apply to all aspects of the present disclosure.

The terminology as set forth herein is for description of the aspects of this disclosure only and should not be construed as limiting the disclosure as a whole. All references to singular characteristics or limitations of the present disclosure shall include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. Furthermore, the phrase “at least one of A, B, and C” should be interpreted as “only A or only B or only C or any combinations thereof”

The coating compositions, articles, and associate methods of making the coating composition or the article of the present disclosure can comprise, consist of, or consist essentially of the essential elements of the disclosure as described herein, as well as any additional or optional element described herein or which is otherwise useful in coating applications.

All percentages, parts, and ratios as used herein are by weight of the total composition, unless otherwise specified. All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

Any combination of method or process steps as used herein may be performed in any order, unless otherwise specified or clearly implied to the contrary by the context in which the referenced combination is made.

1. A fluorine-free coating composition comprising a functionalized poly(siloxane) represented by the formula:
X-A-SiR¹R²—[O—SiR¹R²]ₙ—O—SiR¹R²—B—X
wherein,
X is a trialkoxysilane group at each occurrence,
A and B are divalent groups, respectively,
R¹ and R² are respectively and independently at each occurrence a hydrogen atom, a methyl group, ethyl group, or phenyl group, and
n is an integer from 1 to 150,
wherein the fluorine-free coating composition, when applied to a substrate, forms a transparent hydrophobic coating.

2. The fluorine-free coating composition of claim 1, wherein X is —Si(OCH₃)₃ or —Si(OC₂H₅)₃, independently at each occurrence.

3. The fluorine-free coating composition of claim 1, wherein A and B comprise divalent saturated hydrocarbon groups.

4. The fluorine-free coating composition of claim 3, wherein A and B further comprise urea, urethane, ether, or amide groups, respectively.

5. The fluorine-free coating composition of claim 1, wherein the fluorine-free coating composition is applied to the substrate by physical vapor deposition (PVD), spray coating, dip coating, or drop-on-demand printing.

6. The fluorine-free coating composition of claim 1, wherein the transparent hydrophobic coating has an initial water-air contact angle of 100° or more.

7. The fluorine-free coating composition of claim 1, wherein the transparent hydrophobic coating has a loss of water-air contact angle of less than 15% over 6400 abrasion cycles by cotton fabric with a contact area of 3.6 cm² or more and a total load of 2.5 kg or less.

8. The fluorine-free coating composition of claim 1, wherein the transparent hydrophobic coating has a surface energy of 15-25 mN/m.

9. The fluorine-free coating composition of claim 1, wherein the transparent hydrophobic coating has a water drop sliding angle below 7.5°.

10. The fluorine-free coating composition of claim 1, wherein, when the transparent hydrophobic coating is applied on a smooth, unstructured, and transparent substrate, the transmission of the substrate does not change by more than 1% and the haze of the substrate does not change by more than 1%.

11. A fluorine-free coating composition comprising a functionalized polydimethylsiloxane represented by the formula:
X-D-SiR¹R²—[O—SiR¹R²]ₙ—O—SiR¹R²—Y
wherein,
X is a trialkoxysilane group,
D is a divalent group,
R¹ and R² are hydrogen atom, or methyl, ethyl, or phenyl groups, respectively and independently at each occurrence,
n is an integer from 1 to 150, and
Y is a linear or branched C1-C10 alkyl, phenyl, alkyl phenyl, or alkenyl group,
wherein the fluorine-free coating composition, when applied to a substrate, forms a transparent hydrophobic coating.

12. The fluorine-free coating composition of claim 11, wherein D comprises a divalent saturated hydrocarbon group.

13. The fluorine-free coating composition of claim 11, wherein D further comprises urea, urethane, ether, or amide group.

14. The fluorine-free coating composition of claim 11, wherein X is —Si(OCH₃)₃.

15. A fluorine-free coating composition comprising a functionalized poly(siloxane) represented by the formula:
[C(CₛH₂ₛ₊₁)(QX)₂]-E-SiR¹R²—[O—SiR¹R²]ₙ—O—SiR¹R²—Y
wherein,
X is a trialkoxysilane group,
Q is a divalent group,
E is a divalent group comprising saturated hydrocarbon chain, substituted phenyl, urethane, ether, or ester groups, or combination thereof, R¹ and R² are hydrogen atom, or methyl, ethyl, or phenyl groups, respectively and independently at each occurrence,
n is an integer between 1 and 150,
s is an integer from 0 to 3, and
Y is a linear or branched C1-C10 alkyl, phenyl, alkyl phenyl, or alkenyl group.

16. The fluorine-free coating composition of claim 15, wherein Q comprises a divalent saturated hydrocarbon group.

17. The fluorine-free coating composition of claim 15, wherein Q further comprises a urea, urethane, or thiourethane group.

18. The fluorine-free coating composition of claim 15, wherein X is —Si(OCH₃)₃.
